(19) United States
(12) Patent Application Publication
(10) Pub. No.: US 2002/0083068 A1
(43) Pub. Date: Jun. 27, 2002

(54) Method and apparatus for filling out electronic forms

(76) Inventors: Dallan W. Quass, Elk Ridge, UT (US); Randy Waki, Orem, UT (US); Fernando C. N. Pereira, Philadelphia, PA (US)

Correspondence Address: WHIZBANG! LABS, 3210 NORTH CANYON ROAD SUITE 300, PROVO, UT, 84604, US

(21) Appl. No.: 10/022,176

(22) Filed: Oct. 29, 2001

Related U.S. Application Data
(60) Provisional application No. 60/244,328, filed on Oct. 30, 2000.

(51) Int. Cl. G06F 7/00

(52) U.S. Cl. 707/100

(57) ABSTRACT

A system and method is provided for accessing targeted information concealed behind electronic forms, accomplished by identifying the forms, determining which of the identified forms to fill out, and determining how to populate the fields of the forms to be filled out. Electronic content that might contain electronic forms is subjected to a series of transformations culminating in an object model that exposes the existence of any electronic forms in the content, the logical structure of the fields in those forms including features such as descriptive labels that may assist in the interpretation of the fields, and a mechanism for recording how to populate the fields. A collection of classifiers and their support components, whose composition is largely determined by the specific information being sought and whose implementation may employ techniques from the field of machine learning, are applied to features exposed by the transformations in general and the object model in particular, to make decisions about which forms to fill out, how to populate form fields, and how to cause forms to be submitted. The decisions are then applied to the object model to electronically populate the forms in a number of combinations likely to retrieve the information being sought.

### CROSS-REFERENCE TO RELATED APPLICATIONS

This application is related to and claims priority to U.S. Provisional Application Serial No. 60/244,328, entitled “Method and Apparatus for Filling Out Electronic Forms” filed Oct. 30, 2000, and is herein incorporated by reference.

### BACKGROUND OF THE INVENTION

1. The Field of the Invention

This invention relates generally to computer-controlled location of electronic forms on a network database and, more specifically, locating and electronically populating such forms in order to further access information concealed by the unpopulated electronic form.

2. The Relevant Technology

More and more information is available from electronic sources such as the World Wide Web. This has fostered the appearance of computer-controlled systems that automatically retrieve information to search, monitor, aggregate, reformat, or otherwise process the information. Examples of systems based on automatically retrieved information include Internet search engines and comparison-shopping engines. Electronic forms present a barrier to automated information retrieval, giving rise to the notion of information being “hidden” behind forms. Forms often allow human users to specify search criteria in order to retrieve relevant portions of information. A key characteristic of electronic forms is that they require users to perform one or more actions ranging from a simple mouse click to the entry of complex data prior to allowing the user to proceed deeper into the form where information of interest may be present. This means that automated systems must simulate the proper user actions to retrieve the desired information.

Simple solutions are thwarted by two major factors. First is the diversity of forms. While forms generally draw from a set of well-known controls such as push buttons, check boxes, fill-in-the blank text fields, etc., these controls can be customized and combined to produce a potentially infinite number of overall designs. Second, the number of possible ways to fill out most forms is so large that brute force approaches are generally impractical. Clues to the proper way to fill out a form are usually present but are aimed at human users and can be extremely difficult for automated systems to interpret. Such clues might include explicit directions, labels appearing next to form elements, visual relationships between parts of the form, background knowledge of the subject matter, etc.

Additional obstacles include irrelevant forms (such as a ubiquitous “search this web site” form); redundant forms (such as a form appearing at the top of a page with a duplicate at the bottom); fill-in-the-blank text fields that must be filled out (such as a mandatory e-mail address, a problem because they are not multiple-choice questions); forms that lead to other forms; and forms that do not return their results all at once but rather, say, 10 items at a time, with a “next 10 results” button leading to the next 10 items, and so on, with the possibility of the last page having zero items along with a “next 10 results” button that simply leads back to the same page, raising the potential of an endless loop.

As indicated above, simple brute force approaches break down when faced with forms containing many possible combinations. Such approaches are too inefficient and place too great a burden on the information sources. As stated, this problem is further compounded by the presence of irrelevant or redundant forms, fill-in-the-blank text fields, and “next 10 results” types of buttons.

Some existing form-filling solutions are designed as a convenience utility for individual users. They often operate as add-ins to the user's web browser. They basically act as macros to save typing by recognizing specific kinds of forms, then filling them with canned data such as the user's ID and password. Shortcomings of solutions like this include: a) they only fill a given form once with pre-arranged data; b) they are limited to occasional use by individuals; c) they don't scale up to, say, forms on tens of thousands of different web sites; d) they only work for specific kinds of forms, sometimes only with forms specifically designed to be compatible; and e) they do not address “next 10 results” types of buttons.

Another existing solution that perhaps scales involves matching form elements with a predetermined set of attributes and selecting those attributes. In such an approach, form fields that don't match any predefined attribute are left untouched. Shortcomings of this solution include: a) it is limited to retrieving information about very specific items whose characteristics are known beforehand (for example, this solution cannot retrieve information that requires the selection of unforeseen options; each desired selection must be known beforehand); b) it cannot handle fill-in-the-blank text fields; c) it cannot handle forms that lead to other forms; d) it does not address “next 10 results” types of buttons; and e) it focuses only on form filling and does not integrate well with other kinds of navigation such as hyperlinks.

Another solution attempts to solve the combinatorial explosion of possibilities by submitting the form with its initial default settings, then repeatedly re-submitting it with random combinations of settings. Such a brute-force solution terminates when all data seems to have been retrieved, as determined by a statistical test based on the likelihood of new information being retrieved by additional random settings. An extension to such an approach also employs a threshold that causes the approach to decide that all combinations need to be tried. Shortcomings to such a solution include: a) it can only try to retrieve all available information, not desired subsets; b) it can fail to retrieve all available information because its sampling threshold can be fooled by forms with many possible settings backed by sparse amounts of data; c) it does not avoid irrelevant or redundant forms; d) it cannot handle fill-in-the-blank text fields; e) it cannot handle forms that lead to other forms; and f) it does not address “next 10 results” types of buttons.

### BRIEF SUMMARY OF THE INVENTION

The present invention provides a method that, under computer control, identifies electronic forms, determines which forms to fill out in order to access information concealed behind the forms, determines the various ways in which the form fields should be populated in order to efficiently access the desired information, and electronically fills out the forms in the determined manner. The present invention attempts access to all of the information behind the forms or, alternatively, specific portions. The present invention can recognize and fill out multiple-choice form fields as well as open-ended form fields that may require the entry of arbitrary text.

facilitate efficient recognition and processing of forms, the system may perform a number of successive transformations that convert a candidate electronic document that may contain forms from its original format into other formats that tend to add or accentuate features relevant to forms processing, and remove or reduce features that are irrelevant. In particular, one of the formats into which forms may be transformed is an object model that leverages the principles of object-oriented programming to represent forms effectively.

To help decide which forms to fill out and how to populate their fields, the system may call upon one or more classifiers. Such classifiers could operate on an object model and also alter the object model's state in order to record their conclusions. A classifier examines an input item such as an entire document, a form, a form field, a set of form fields, etc., and chooses from a list of possible classifications the one that most likely describes the input item. A classifier might also return a confidence level for its classification. Classifiers can use many techniques to perform their classification tasks, particularly techniques from the field of machine learning. Machine learning techniques can allow some classifiers to be initially constructed and then adapt to specific domains by being trained to recognize input items from that domain. Classifiers can also call upon other classifiers and other program code, with other program code also calling upon classifiers, alternatively using machine learning techniques to arrive at effective arrangements.

For example, to determine whether a form should be filled out, a classifier might classify a form as either “fill it out” or “do not fill out”. This decision might be based on how the form's fields are classified by other classifiers. A classifier might classify a form field as “leave it alone”, “select one option”, or “spin through several options”. Another classifier might classify each option in a form field as “choose it” or “do not choose it”. To determine which option to choose for a form field classified as “select one choice”, other program code might choose the option whose “choose it” classification has the highest confidence.

The invention also provides a system and method that electronically fills out forms. This may involve examining the state of an object model and generating a series of electronic requests, each representing a submission of the form populated in a particular way. Sending these electronic requests and receiving their results approximates what might have happened if a human user had manually filled out the electronic form.

These other objects and features of the present invention will become more fully apparent from the following description and appended claims, or may be learned by practice of the invention as set forth herein.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a diagram of a conventional web crawler having application to the preferred embodiment of the present invention;

FIG. 2 is a flowchart illustrating a method by which a web crawler traverses the web having application to the preferred embodiment of the present invention;

FIG. 3 depicts an exemplary electronic form for being traversed according to the present invention;

FIG. 4 is diagrammatic overview of a form filling system implemented using a web crawling approach, in accordance with a preferred embodiment of the present invention;

FIG. 5 illustrates exemplary computer-readable instructions capable of presenting the electronic form exhibited in FIG. 4;

FIG. 6 illustrates computer-readable instructions that have been converted from those exhibited in FIG. 5, in accordance with a preferred embodiment of the present invention;

FIG. 7 illustrates a form parser, in accordance with a preferred embodiment of the present invention;

FIG. 8 illustrates a UML class diagram describing an exemplary electronic form in an object model, in accordance with a preferred embodiment of the present invention;

FIG. 9 is a flowchart of an exemplary category classifier for determining if a form field coincides with a list of acceptable categories, in accordance with a preferred embodiment of the present invention; and

FIG. 10 is a flowchart illustrating a method for filling out a form, in accordance with a preferred embodiment of the present invention.

### DETAILED DESCRIPTION OF THE PREFERRED EMBODIMENTS

The invention will be described in the context of a web crawler that automatically visits web pages looking for particular information. The invention allows the crawler to fill out forms so it can visit web pages hidden behind the forms. The use of such a context is not meant to imply that the invention's usefulness is limited to that context. While the present illustrative embodiment describes a web-based environment, other applications, including local and wide area networks, self-contained applications for traversing electronic forms and retrieving information therebehind in a non-network based application are also contemplated by this invention. Additionally, the present illustrative embodiment also illustrates the exemplary embodiment using a specific descriptive language, namely HTML and XHTML. The present invention contemplates other descriptive languages that also may be utilized for implementing the present invention and are also contemplated within the scope of the present invention.

By way of example and not limitation, the present embodiment is illustrated by describing a web crawler for traversing web pages followed by a description of a flowchart describing an exemplary method of operation of a web crawler within the preferred embodiment of the present invention. Electronic forms including the method of overcoming the shortcomings of prior approaches is then described. The preferred embodiment of the present invention is then described.

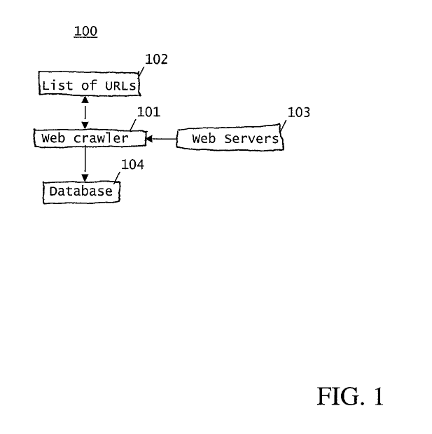

FIG. 1 is a diagram of a conventional web crawler 100. The web crawler 101 starts with an initial URL list 102 to be visited. The web crawler 100 retrieves the web page at each of these URLs by requesting the specific web pages from an appropriate web server 103, in accordance with normal networking or Internet practices known and appreciated by those of skill in the art. The web crawler may save the web page in a database 104. It may also discover within the specific web page links to additional URLs that should be visited, and add those URLs to the URL list 102 for subsequent retrieval.

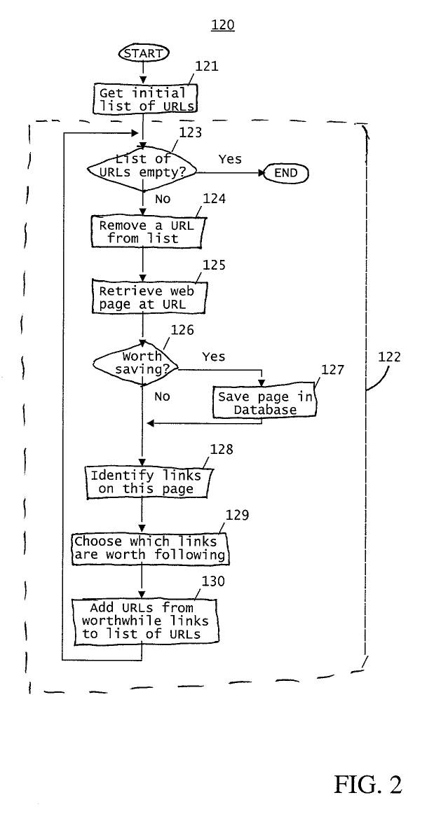

FIG. 2 is a flowchart of an exemplary method 120 by which a web crawler 101 (FIG. 1) visits web pages. Web crawler 101 visits an initial list of web pages, plus additional web pages that are reachable from the initial set, in order to retrieve particular information of interest to the user of the present invention. Referring to FIG. 2, in a step 121, the web crawler 101 obtains the URL list 102 (FIG. 1) identifying the initial web pages to be visited. The web crawler 101 then enters a loop 122 and begins processing the URLs in the list 102 one at a time until each of the URLs has been traverse, or in other words, until step 123 determines that the list is empty.

If the list is not empty, meaning each of the URL candidates on URL list 102 has not been evaluated, then in a step 124 the web crawler 101 removes a URL from the list for evaluation and processing. In a step 125, the web crawler retrieves the web page identified by the removed URL using traditional Internet procedures, known by those of skill in the art, for web page retrieval. Once the web page has been retrieved, the web crawler 101 decides in step 126 whether the page is of interest and therefore worth saving, using, for example, the nature of the particular information being sought to guide its decision. If the page is worth saving, it is saved in the database 104 (FIG. 1) in a step 127.

In a step 128, the web crawler examines the page for linking mechanisms that would allow users using a web browser to navigate to other web pages. In the networked example of the Internet using HTML, web crawlers typically support the most common linking mechanism of a simple hyperlink represented by an <a> tag in the web page's HTML code. This kind of hyperlink often appears as underlined text or a graphic image that, when clicked on by the user, causes the browser to retrieve and display another web page. In this kind of link, each link generally leads to a single web page.

Forms introduce a more complex linking mechanism and present a greater challenge for a web crawler to support since a given form may be filled out in a variety of ways, which may potentially lead to an arbitrary number of web pages. Having identified the page's links, the web crawler, in a step 129, evaluates and selects links that appear to be of similar interest and worth following, for example, by using the nature of the particular information being sought to guide its choice.

Next, in a step 130, the web crawler adds to the URL list 102 (FIG. 1) the URLs for the links of interest (i.e., the worthwhile links). The web crawler then returns for another cycle through loop 122. Rational selections made in step 129 (e.g., avoiding a return to web pages that have already been visited) allow step 125 to be performed for each initial URL obtained in step 121 and each additional URL added in step 130. The web crawl terminates upon the detection of an empty list of URLs, as determined by step 123, resulting in an exit of loop 122.

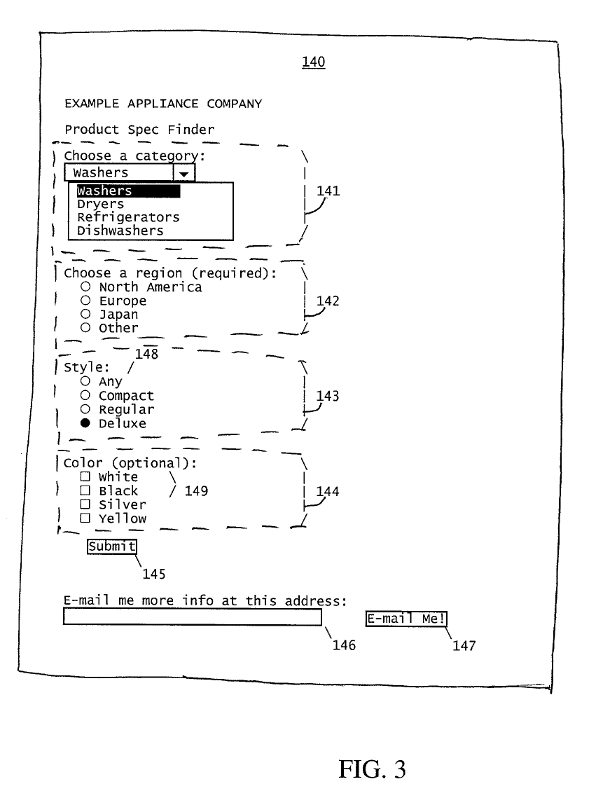

FIG. 3 is a depiction of an exemplary electronic form 140 that might appear on a web page or other electronic form presentation system. Electronic forms often times act as gate-keepers preventing access to “deeper” information without requiring divulgence of information into the electronic form. Therefore, as is frequently the case, the only way to reach certain web pages is by filling out or populating such a form. The present invention utilizes automation for probing or populating the fields within the form in order to access the information behind the forms.

By way of example, exemplary electronic form 140 is arbitrarily illustrated to have four form fields, 141-144, that allow the user choose various combinations, for example, an appliance category 141, a geographic region 142, a style 143, and a color 144. Electronic form 140 is illustrated to further include a submit button 145 that generally results in the form being submitted with its current settings. Further illustrated in FIG. 3 are other fields that may be elective or optional fields such as a text field illustrated as an e-mail address in text field 146 followed by an email address submit button 147.

Those of skill in the art appreciate that every different combination of settings in form 140 could cause the form to return a different web page. While it is feasible, it has also been found that it may also be impractical (i.e., computationally excessive or unnecessary) to try all possible combinations of settings because they may be numerous. For example, text fields such as 146 are particularly resistant to attempts at all possible combinations because they typically allow arbitrary text to be entered. The number of necessary settings that need to be considered may be reduced using cognitive skills. For example, if color distinctions are irrelevant to the information being sought, it may be recognized that leaving the color settings 144 unspecified is likely to return the same information as checking all four colors, which in turn is likely to return the same information in a single form submission as four submissions using each of the available colors individually. If information about black or white appliances is being sought, it is probably sufficient to simultaneously check the White and Black options 149 and ignore all other combinations of color settings. If the information being sought is product specifications for appliances, text field 146 and button 147 are probably irrelevant and can be left untouched.

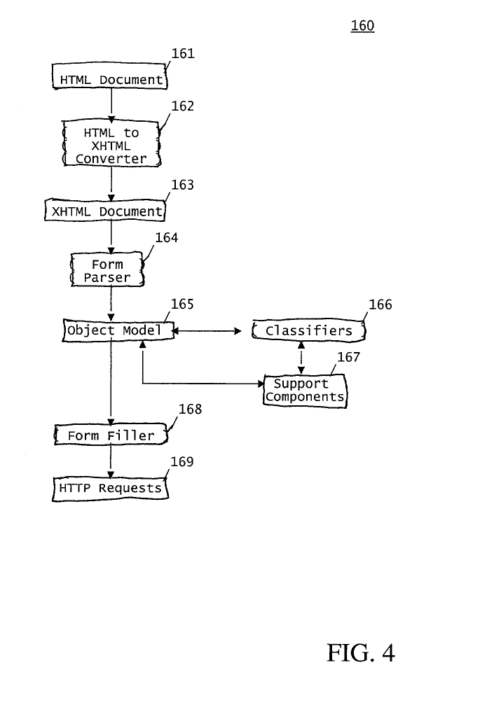

FIG. 4 is a diagrammatic overview of a form filling method and system 160 for a web crawler in accordance with the invention. In the preferred web embodiment, the method receives from the web crawler a candidate HTML document 161 which may contain electronic forms to be filled out prior to allowing “deeper” information to be accessed. The candidate HTML document corresponds to the web page used in step 128 of FIG. 2. The present embodiment provides for a series of transformations on the HTML document 161 in order to arrive at a representation that brings out features relevant to form filling, with an alternative use of classifiers on those features to make decisions about form filling, followed by action on those decisions.

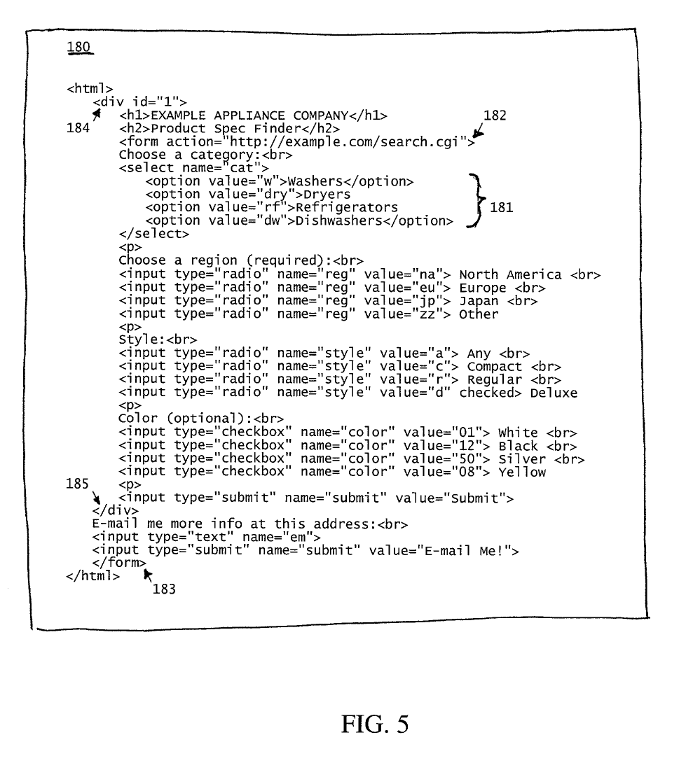

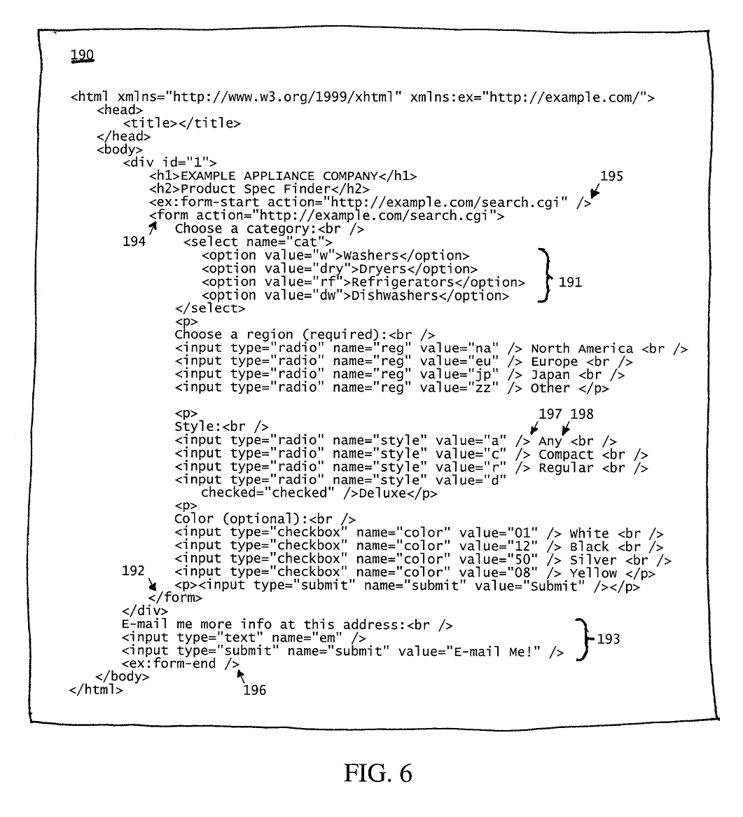

First an HTML-to-XHTML converter 162 converts the candidate HTML document 161 into a candidate XHTML document 163. Further details about HTML-to-XHTML converter 162 will be discussed in conjunction with FIGS. 5 and 6.

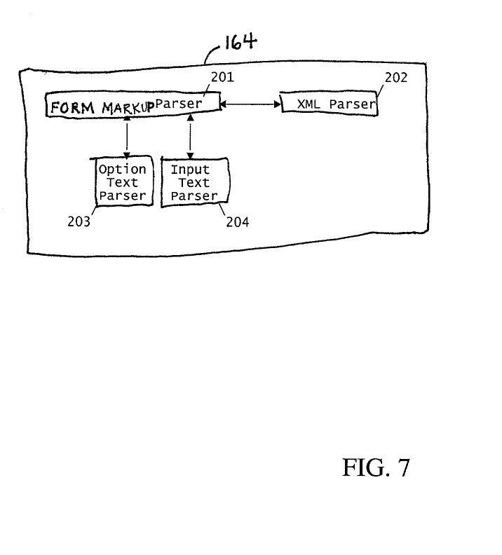

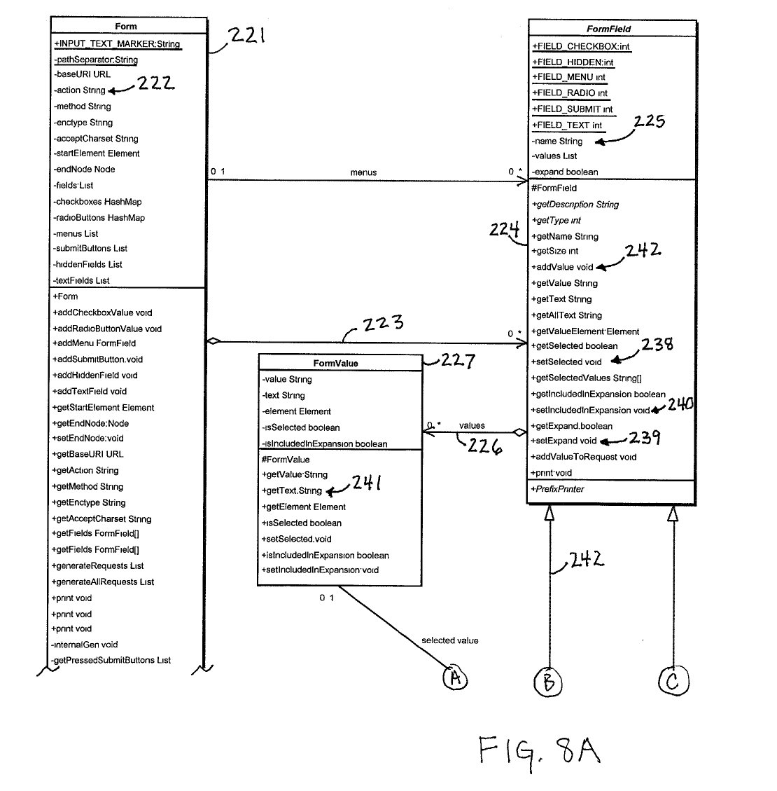

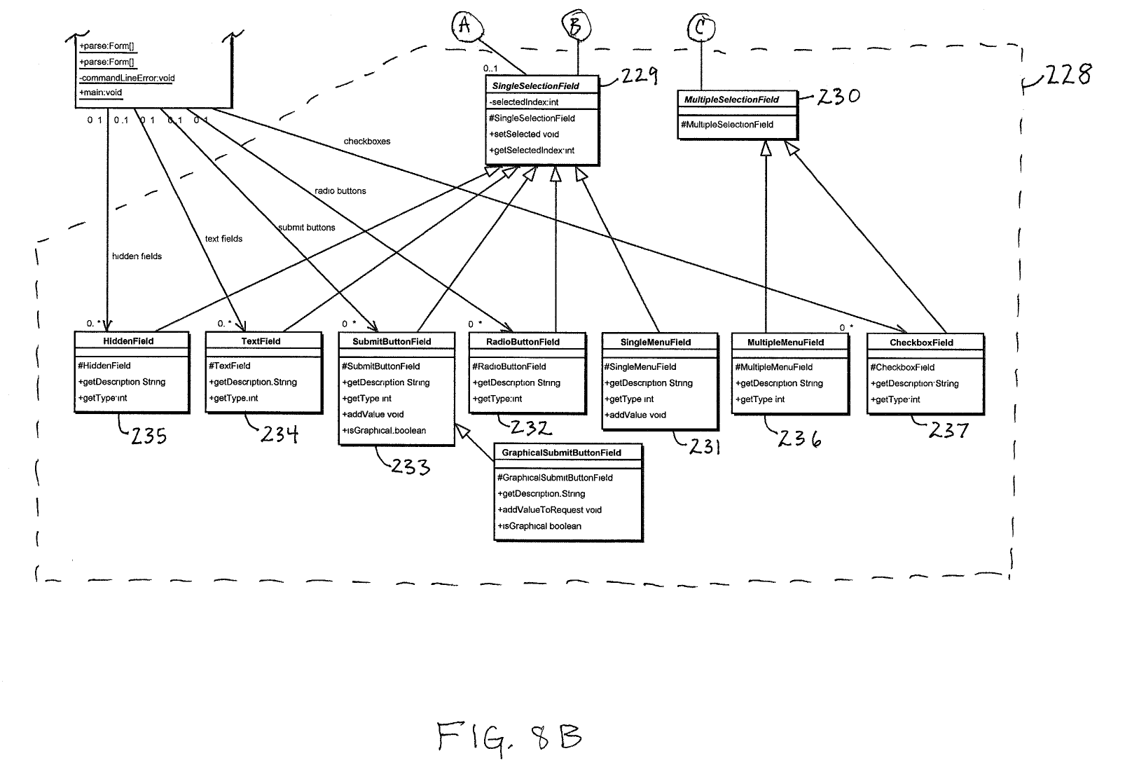

In a subsequent step, a form parser 164 searches the candidate XHTML document 163 for the presence of electronic forms and converts any discovered electronic forms into an object model representation 165. Further details about form parser 164 and object model 165 are discussed in conjunction with FIGS. 7 and 8.

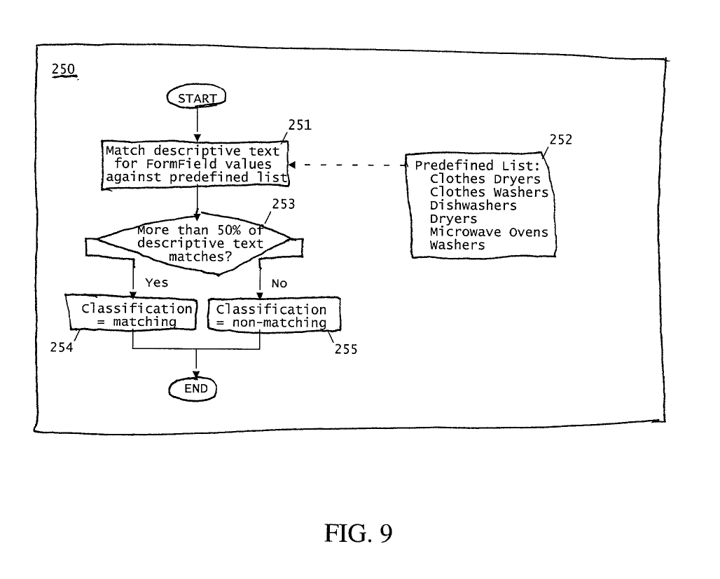

One or more classifiers 166 then determine which forms should be filled out and how to do so. Classifiers 166 make their determination using each electronic form's object model 165. Classifiers 166 may also employ the candidate XHTML document 163 and the candidate HTML document 161 in the determination process. Classifiers 166 may also use additional support components 167, the exact nature of which generally depends on the classifiers being used. Further details about classifiers 166 and support components 167 are discussed in conjunction with FIG. 9.

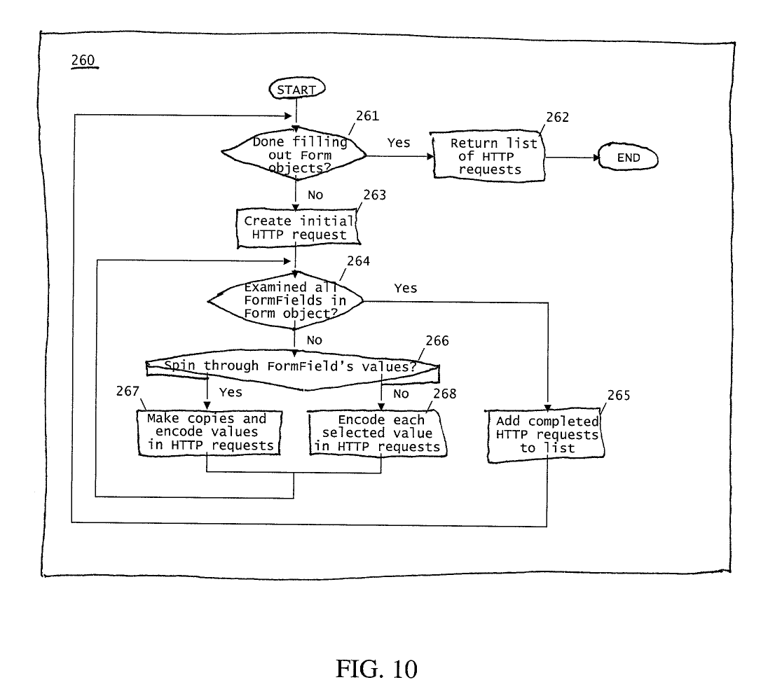

Subsequently, a form filler 168 uses object models 165 and the classifiers' decisions to fill out the forms. Form filler 168, in the preferred embodiment, produces a list of HTTP requests 169. Integration of the form-filling aspect of the present invention into an existing web crawler may be facilitated by allowing the web crawler to support/handle HTTP requests rather URLs. Further details about form filler 168 and HTTP requests 169 are discussed below in conjunction with FIG. 10.

FIG. 5 illustrates sample HTML code 180 representative of an electronic form such as that depicted in FIG. 3. HTML code 180 is an example of an HTML document 161 in FIG. 4. By way of example, HTML code 180 exhibits two, among many irregularities that occur in actual deployed HTML code. First, option elements 181 are illustrated with inconsistencies, namely some of the option elements terminate or end with the designator “</option>” while others do not. Such inconsistencies while permitted in HTML code, nevertheless complicate correct interpretation of the HTML code. Second and potentially more serious for form filling, the designator “<form>” start tag 182 and the “</form>” end tag 183 are incorrectly positioned relative to one another because one occurs inside the area bounded by “<div>” 184 and “</div>” 185 while the other occurs outside. Positioning such as this is not formally permitted by HTML, yet such discrepancies occurs and are commonplace due to the unstringent implementations of web browsers. The present invention removes inconsistencies and irregularities when the HTML document is converted into an XHTML document as described below.

FIG. 6 shows sample XHTML code 190 that an HTML-to-XHTML converter 162 (FIG. 4) might produce for the sample HTML code 180 (FIG. 5). Generally, XHTML is a standardized, more regularized version of HTML. XHTML is generally more consistent to process than HTML. By converting to XHTML, many of the difficulties of correctly interpreting HTML can be isolated in this HTML-to-XHTML converter, helping to simplify other parts of the system. XHTML also supports the inclusion of custom tags, which converter 162 can use to convey additional information beyond that provided for by standard XHTML.

Returning to FIG. 6, in the exemplary XHTML code 190, the conversion has made the option elements 191 more consistent by terminating each one with “</option>”. The conversion has also moved the “</form>” end tag 192 to a permitted position, but in doing so has caused a portion 193 of the original form to occur outside of the area now bounded by <form>194 and </form>192. This could make it very difficult for a form parser to recognize that the portion 193 should be part the form. To compensate for situations like this, converter 162 utilizes XHTML's support for custom tags by inserting custom tags 195 and 196 to mark the form's original boundaries. For example, a custom tag 196 has been inserted where the “</form>” end tag 192 was originally located. A form parser, such as 164 of FIG. 4, could then use these custom tags to determine the form's original boundaries. While custom tags are preferable, other markers might have been used such as comments or processing instructions.

FIG. 7 shows a diagrammatic view of a form parser 164 in accordance with the invention. This form parser parses an XHTML document such as the sample 190 shown in FIG. 6 and produces for each form found an instance of the object model 165 properly initialized to reflect any default selections in the form. A form parser 164 might bypass HTML-to-XHTML conversion and directly parse HTML documents, but such a form parser would likely be much more complex to construct. To assist it in parsing XHTML documents, this form markup parser 201 uses an off-the-shelf XML parser 202. Off-the-shelf XML components such as XML parsers can be used because XHTML is based on the XML standard. To locate form boundaries more reliably, this form parser prefers to rely on inserted markers such as custom tags 195 and 196, but it can also use standard <form>start tags 194 and </form>end tags 192 if necessary or desired.

A form parser might also further attempt to compensate for some HTML and/or XHTML irregularities, particularly if they are form-related since more detailed information about forms may be available in a form parser than in, say, an HTML-to-XHTML converter.

A form parser can use additional components to help gather information that may prove useful to the form filling process. For example, an OCR (Optical Character Recognition) component might be employed to recognize fancy characters embedded in a graphic image and convert them into regular text strings. Another example, described in the next few paragraphs, is a separate parser that tries to find descriptions for form controls.

Each form control is usually associated with descriptive text, icons or other graphics, etc. that suggest the form control's purpose. The association between form controls and their descriptions is often implicit, possibly based on how things are laid out in the form. An example of this can be seen in FIG. 3 where the first style option 148 would seem to be clearly labeled “Any”, but in the underlying XHTML code shown FIG. 6, the <input>element 197 representing the actual form control and the “Any” text 198 describing it are not explicitly associated with one another. They happen to be adjacent, but that does not necessarily imply an association in XHTML.

Form parser 164 may further include two additional parsers, an option text parser 203 and an input text parser 204, to obtain descriptions for XHTML <option>elements and XHTML <input>elements respectively. The descriptions obtained by these two parsers are plain text strings although other formats are certainly possible; for example, the descriptions could be references into the XHTML code so that formatting information (such as font size, line spacing, etc.), context information (such as relative positioning in a table or proximity to other XHTML elements), etc. could be preserved in the descriptions. These two parsers could also provide the ability to identify the areas of the XHTML document 163 from which they obtained descriptive text; for example, by inserting additional markup into the XHTML code 190 to cause the areas to be to displayed in some distinctive color in a web browser with, say, small identifying numbers beside the form controls and the descriptions so they can be matched up visually.

The option text parser 203 returns the text between an <option>element's <option>start tag and </option>end tag. An option text parser could also consider other potential sources of descriptive text such as text appearing in attributes on an <option>start tag itself, text that might be generated dynamically by script, or other text whose wording suggests that it refers to a form control.

The input text parser 204 uses an ordered list of rules to find descriptive text for an <input>element. It returns the text from the first rule that succeeds in finding text that is more than just blank spaces. If no rules succeed, the input text parser indicates that the <input>element has no descriptive text. The rules are, in order: (1) look for any text following, and on the same line as, the <input>element; (2) look for any text preceding, and on the same line as, the <input>element; (3) if the input element is inside a table cell, look for any text in the table cell following, and on the same table row as, the <input>element; (4) if the input element is inside a table cell, look for any text in the table cell preceding, and on the same table row as, the <input>element. In addition, whichever of rules (1) and (2) succeeds most often on a given line are used uniformly for that line, and whichever of rules (3) and (4) succeeds most often on a given table row are used uniformly for that row. This is a heuristic based on the observation that descriptions on a given line or table row tend to appear consistently on either the right or the left, but not both, of form controls. For the previously cited example in FIG. 6, rule (1) would succeed in finding the “Any” text 198 for the <input>element 197.

FIG. 8 is a UML class diagram describing a form object model 220 in accordance with the invention. By way of example, an object model, using the programming technique known as object-oriented programming, can represent a system as a collection of cooperating, self-contained entities called objects, with well-defined relationships between the objects. UML class diagrams are a standard way to graphically describe object models. Boxes in UML class diagrams represent objects such as Form objects 221, and lines in UML class diagrams represent relationships between objects such as line 223 which indicates that each Form object 221 owns zero or more FormField objects 224. Lines with hollow arrowheads indicate inheritance which means that characteristics of the object pointed to are implicitly included in (“inherited by”) the object from which the arrow emanates; for example, line 242 indicates that SingleSelectionField 229 inherits from FormField 224, so a SingleSelectionField implicitly includes methods such setSelected 238.

This form object model 220 provides a higher-level, more convenient representation of XHTML forms than a naive translation of XHTML tags would produce. For example, XHTML radio buttons are logically organized into, and manipulated as, groups of mutually exclusive buttons such as the region options 142 shown in FIG. 3. However, such groups do not actually exist in the XHTML code; rather, the groups are inferred when individual radio buttons happen to share the same name. The object model 220 explicitly models radio button groups as RadioButtonField objects 232, thus reducing bookkeeping details to make forms easier to examine and manipulate.

By way of example, a Form object 221 represents an entire electronic form. The form parser 200 shown in FIG. 7 returns a Form object for every form it finds. A Form object supports features and operations that apply to the overall form, such as remembering the URL to which the form should be submitted, contained within the action attribute 222, or maintaining a list of the form's fields, indicated by line 223 leading to FormField objects 224.

A FormField object 224 is an abstraction for a form field regardless of type. It supports features and operations typical of all form fields, such as remembering the name of the form field, indicated by the name attribute 225, or maintaining a list of individually selectable options, indicated by line 226 leading to FormValue objects 227.

Subclasses 228 of FormField extend the base functionality of a FormField to represent specific types of form controls. The subclasses first divide form controls according to whether they support the selection of one value at a time 229 or multiple values 230. This division makes it easier to know if multiple values can be submitted simultaneously when HTTP requests are generated later.

Subclasses supporting single value selection may include a SingleMenuField 231 corresponding to a menu of choices such as the category options 141 in FIG. 3, a RadioButtonField 232 corresponding to a group of radio buttons such the region options 142, a SubmitButtonField 233 corresponding to a submit button such as the submit button 145, a TextField 234 corresponding to a text field such the e-mail address field 146, and a HiddenField 235 corresponding to a hidden field which is invisible but can affect how the form functions.

Subclasses supporting multiple value selection include a MultipleMenuField 236 corresponding to a menu of choices that supports multiple selections and a CheckboxField 237 corresponding to a group of checkboxes such as the color options 144. A form object model could include additional subclasses to represent additional types of form controls, such as new ones that might be defined in a future version of HTML or XHTML.

In addition to representing the static structure of a form, a form object model can provide the ability to represent how a form should be filled out. In this object model, this is accomplished in the following way: if a form field does not need to be changed, its corresponding FormField object 224 is left unchanged; if a form field needs to be changed once for all form submissions, the setSelected method 238 in the form field's corresponding FormField object is used to specify which form values should be selected; if a form field needs to spin through some or all of its values to produce multiple form submissions, the setExpand method 239 and the setIncludedInExpansion method 240 in the corresponding FormField object are used to indicate respectively that values need to be spun through and which values to spin through. Each FormField that spins through its values multiplies the total number of times the form needs to be submitted by the number of values spun through.

Since, for example, SubmitButtonField objects 233 and TextField objects 234 inherit from FormField objects 224, the previous description of setting up a FormField to be filled out applies to them although the terminology might need some clarification. A typical SubmitButtonField has one and only one value. Calling the setSelected method 238 for that value will cause the submit button to be pressed. A typical TextField starts out with no values. Values may be added later, each value representing a separate string to be entered into the text field. Calling the setSelected method 238 for one of these values causes that value to be entered into the text field. Calling the setExpand method 239 and the setIncludedInExpansion method 240 causes multiple values to be spun through.

A form object model can also be the source of supplemental information. For example, the descriptive text obtained by the OptionTextParser 203 and the InputTextParser 204, as previously described in conjunction with FIG. 7, is available in this object model through the getText method 241 of FormValue 227.

An object model can be manipulated by any program code, not just classifiers 166 and their support components 167 as shown in FIG. 4. For example, an object model could be used to fill out specific forms by program code tailored to access a particular web site or family of web sites, with no classifiers involved.

FIG. 9 is an illustrative flowchart 250 of an example classifier illustrated as an appliance category classifier that determines whether or not a FormField object 224 represents a list of appliance categories. Step 251 matches the descriptive text for the FonnField's values against a predefined list of potential appliance categories 252. In the case of the category options 141 in FIG. 3, “Washers”, “Dryers”, and “Dishwashers” would match while “Refrigerators” would not. Step 253 checks if the percentage of values with matching descriptive text exceeds a threshold, for example, of 50%. If so, step 254 classifies the FormField as “matching”, otherwise step 255 classifies the FormField as “non-matching”. This simple classifier would classify the category options 141 in FIG. 3 as “matching” since 3 out of 4 values match, thus correctly identifying the options as appliance categories. This information could then be used to make additional decisions. For example, a support component 167 could decide that any form containing an appliance category FormField should be filled out, and that all appliance categories actually listed in the form should be submitted. In this manner, the form 140 could be filled out for the category “Refrigerator” even though “Refrigerator” was an unknown category not present in the predefined list 252.

This example appliance category classifier illustrates only one of the ways in which classifiers 166 in FIG. 4 could be employed in accordance with the invention. In general, a classifier could use any combination of information obtained from an object model 165, an XHTML document 163, an HTML document 161, support components 167, and other classifiers 166. The information available from an object model can be particularly useful if the object model exposes features that tend to indicate which classification is best, such as the descriptive text used by the simple appliance category classifier.

A classifier does not necessarily have to produce a yes-or-no decision. A classifier might choose from multiple classifications. For example, a classifier might classify a FormField object 224 as one of: (1) spin through all values; (2) choose one particular value; (3) don't change anything. For classification (2), the particular value chosen might be identified by a support component 167 or by another classifier 166. Classification (3) might be the decision the classifier reverts to if it cannot pick (1) or (2) with sufficient confidence. A classifier might also return a confidence level for its classification, perhaps to be used in resolving conflicting classifications from multiple classifiers. For example, if a classifier identifies more than one form per document that should be filled out, the one whose “fill it out” decision has the highest confidence might be chosen.

Another example of a task that a classifier 166 could perform to assist in form filling is to compensate for a quirk that sometimes appears in an HTML form. Sometimes form controls that might seem to be in the same group actually exist in independent groups of one. For example, the HTML code for the region options 142 and the style options 143 in FIG. 3 might have put each individual radio button in its own independent group. This could make it difficult for a form filling system to associate the “Any” radio button 148 with the other style radio buttons and to recognize that it in fact might subsume them, while at the same time not confusing it with the region radio buttons. A classifier might be able to determine the correct grouping by looking for radio buttons existing in groups of one, matching the XHTML tag structure around them, and assuming that all such radio buttons with the same surrounding XHTML tag structure must really belong to an assumed common group. The surrounding XHTML tag structure would serve to keep the region radio buttons in one assumed group and the style radio buttons in another.

Flowchart 250 is only one of the ways in which classifiers 166 could perform their classification task. Classifiers might use advanced techniques from the broad field of machine learning, which can make them especially useful in complex situations. For example, a classifier might compute whether a SubmitButtonField 233 is the correct submit button to press by using a machine learning technique that can take into account a large number of features. Such features might include whether the button's text contains indicative keywords like “submit” or “search”, whether the button's text contains contraindicative keywords like “reset” or “e-mail”, whether there are other submit buttons in the form, whether the button is the first button in the form, etc. The presence or absence of these features might be combined mathematically to compute an overall probability, with the classification being made according to whether the probability exceeds a threshold. The classifier might have been previously trained how to best combine the features by examining examples of forms whose correct submit buttons have already been correctly identified, and adjusting parameters in order to best classify those examples. Specifics about such techniques are the subject of active research.

Filling out a field such as the e-mail address field 146 in FIG. 3 may pose special problems because it is not asking a multiple-choice question. Such fields could simply be ignored, but sometimes it is a required field and a form will not return the desired information unless it is filled in. For example, form 140 might have required an e-mail address in field 146 before returning any information. One way this might be handled in accordance with the invention is for a support component to call upon a classifier to determine if a TextField object 234 looks like it is asking for a required e-mail address; if so, the support component could call the TextField's addValue method 242, which is inherited by the TextField from FormField 224, to add some fixed e-mail address to be filled in. Another perhaps more difficult example is a text field that requires keywords to be entered. In this case, a support component might call upon a classifier to determine if a TextField object 234 looks like it asking for a required keyword; if so, the support component could call the TextField's addValue method 242 to add some keywords to be tried. The keywords might be the same for all such text fields, vary according the web site's URL as might be determined from the URL to which the form is submitted, be adjusted based on keywords that proved successful in the past, etc.

Sometimes filling out one form leads to another form. The form filling system 160 could be applied to each layer of forms. Information about the layering, such as the layering depth and characteristics of previous layers, might be maintained by a support component, passed along in the document itself, etc., and could affect how the classifiers 166 and support components 167 behave. For example, different sets of classifiers could be used for different layers. A common example of layered forms is when a form submission produces a long list of items but the resulting web page contains only the first, say, 10 items, with a “Next 10” button that leads to the next 10 items, and so on. Such buttons are often just small forms containing little more than a submit button that needs to be pressed. A classifier could recognize and press such a button, distinguishing it from a possible “Previous 10” button. A classifier might also detect a potential endless loop, perhaps by recognizing that a page contains zero items.

One of the ways in which the form filling system 160 shown in FIG. 4 facilitates the use of classifiers is by transforming the original HTML document 161 into an XHTML document 163 and then into an object model 165. Each of these transformations can expose features that are increasingly more germane to the classifiers being employed. This can help make classifiers simpler than if they, for example, worked only on an HTML document or an XHTML document. This form filling system can also simplify the training of classifiers since the HTML-to-XHTML converter 162 and the form parser 164 could be largely independent of the decisions to be made by the classifiers 166. This does not preclude the possibility that an HTML-to-XHTML converter or a form parser might themselves use classifiers to assist in their tasks.

In general, some of the major things classifiers may be used for include deciding: (1) whether or not to fill out a form; 2) how to handle each form field when filling out a form; and 3) which submit button(s) to press, if any. Specifics about the classifiers 166 and the support components 167, including how they interact, how they affect the object model 165, the training examples that may have been used to train classifiers, etc., may be customized to the circumstances such as the type of information being sought, the nature of the information source, etc. For example, the set of classifiers and support components needed to retrieve job listings from job search forms might be very different from those needed to retrieve book titles from card catalog search forms. The training examples used to train classifiers might be quite different for instance. By allowing classifiers and support components to be adapted to the needs of specific applications, this invention could be applied to a variety of domains and could take advantage of new discoveries in the field of machine learning.

FIG. 10 is a flowchart 260 of a form filler in accordance with the invention. Step 261 checks if all Form objects 221 that need to be filled out have been filled out. If so, step 262 returns the list of resulting HTTP requests. Otherwise step 263 creates an initial HTTP request using information from the Form object such as the URL to which the form should be submitted. Step 264 then checks if all FormField objects 224 in the Form object have been examined. If so, step 265 adds any completed HTTP requests to the list of resulting HTTP requests, then loops back to check for another Form object to fill out. Otherwise step 266 checks if the FormField's values are to be spun through. If so, step 267 makes copies of the HTTP requests created so far for this Form object, one copy for each value to be spun through, and encodes the values into the copies. This step multiplies the number of HTTP requests in order to submit the desired combinations of form settings. If the FormField's values are not to be spun through, step 268 encodes the FormField's selected values, if any, into the HTTP requests. Steps 267 and 268 both loop back to step 264 to check for another FormField.

While forms normally have a submit button that needs to be pressed, some forms can be submitted in a browser without the user pressing a submit button. For example, a form might consist of a single menu and no submit button, with JavaScript code in the form automatically submitting the form as soon as a user picks an option from the menu. To allow for this possibility, this form filler does not require a submit button to be pressed. It treats submit buttons as just another FormField that may or may not get used.

This form filler produces a list of HTTP requests, where each HTTP request corresponds to a single submission of a form with a particular combination of settings. HTTP requests are similar to URLs but provide better support for form submissions. Some forms require the use of an Internet protocol known as HTTP POST. A URL is a string and cannot represent an HTTP POST. An HTTP request is a data structure that can store the individual pieces of data that comprise any HTTP request including an HTTP POST. An HTTP request could also store the string that would comprise a URL, so HTTP request could be a superset of URLs.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An automated method for obtaining targeted information from a database accessible through an electronic form, said method comprising the steps of:
a. retrieving electronic data having electronic-form data representative of said electronic form therein from a database host;
b. building an electronic-form object model including at least one form field of said electronic-form data;
c. evaluating in a classifier said electronic-form object model to determine a likelihood of said targeted information in said database as accessible through said electronic form;
d. when said classifier determines said targeted information likely exists within said database, populating said at least one form field of said electronic-form object model with valid field data;
e. initiating a request including said valid field data to said database host; and
f. receiving said targeted information from said database

2. The method, as recited in claim 1, wherein said electronic data is in HTML format and said method further comprises the step of:
a. subsequent to said retrieving step, converting said electronic data from said HTML format into XHTML format.

3. The method, as recited in claim 2, further comprising the step of:
a. subsequent to said converting step, parsing said electronic data to isolate said electronic-form data from other portions of said electronic data.

4. The method, as recited in claim 1, wherein said populating step comprises the steps of:
a. creating an initial HTTP request to be sent to said database host;
b. for each of said at least one form field of said electronic-form object model,
i. examining each of said at least one field to determine each of said valid field data;
ii. for said each of said valid field data,
1. inserting said each of said valid field data into said at least on field; and
2. generating HTTP requests from said each of said valid field data when inserted into said at least one field.

5. The method, as recited in claim 1, wherein said populating step comprises the steps of:
a. creating an initial HTTP request;
b. for each of said at least one form field of said electronic-form object model,
i. determining if said at least one form field includes values to be spun through;
1. when said values corresponding to said at least one form field are to be spun through, making copies of an HTTP request created for said at least one form field and encoding each of said values into each of said copies of an HTTP request; and
2. when said values corresponding to at least one form field are not be spun through, encoding said values into an HTTP request.

6. The method, as recited in claim 1, wherein said database host is resident on a wide area network.

7. The method, as recited in claim 6, further comprising the step of:
a. obtaining a list of an initial set of URLs upon which to perform said method.

8. The method, as recited in claim 7, wherein said retrieving electronic data step comprises the steps of:
a. for each URL of said initial set of URLs,
i. issuing a request to said URL; and
ii. receiving said electronic data from said URL;
b. when said electronic data from said URL includes additional URLs, adding said additional URLs to said list of URLs.

9. In a method for obtaining targeted information from a database accessible through an electronic form, a computer-readable medium comprising computer-executable instructions for performing the steps of:
a. retrieving electronic data having electronic-form data representative of said electronic form therein from a database host;
b. building an electronic-form object model including at least one form field of said electronic-form data;
c. evaluating in a classifier said electronic-form object model to determine a likelihood of said targeted information in said database as accessible through said electronic form;
d. when said classifier determines said targeted information likely exists within said database, populating said at least one form field of said electronic-form object model with valid field data;
e. initiating a request including said valid field data to said database host; and
f. receiving said targeted information from said database

10. The computer-readable medium, as recited in claim 9, wherein said electronic data is in HTML format and said computer-readable medium further comprising computer-executable instructions for performing the step of:
a. subsequent to said retrieving step, converting said electronic data from said HTML format into XHTML format.

11. The computer-readable medium, as recited in claim 10, further comprising computer-executable instructions for performing the step of:
a. subsequent to said converting step, parsing said electronic data to isolate said electronic-form data from other portions of said electronic data.

12. The computer-readable medium, as recited in claim 9, wherein said computer-executable instructions for performing said populating step comprises computer-executable instructions for performing the steps of:
a. creating an initial HTTP request to be sent to said database host;
b. for each of said at least one form field of said electronic-form object model,
i. examining each of said at least one field to determine each of said valid field data;
ii. for said each of said valid field data,
1. inserting said each of said valid field data into said at least on field; and
2. generating HTTP requests from said each of said valid field data when inserted into said at least one field.

13. The computer-readable medium, as recited in claim 9, wherein said computer-executable instructions for performing said populating step comprises computer-executable instructions for performing the steps of:
a. creating an initial HTTP request;
b. for each of said at least one form field of said electronic-form object model,
i. determining if said at least one form field includes values to be spun through;
1. when said values corresponding to said at least one form field are to be spun through, making copies of an HTTP request created for said at least one form field and encoding each of said values into each of said copies of an HTTP request; and
2. when said values corresponding to at least one form field are not be spun through, encoding said values into an HTTP request.

14. The computer-readable medium, as recited in claim 9, wherein said computer-executable instructions further comprise computer-executable instructions for performing the step of:
a. obtaining a list of an initial set of URLs upon which to perform said method.

15. The computer-readable medium, as recited in claim 14, wherein said computer-executable instructions for performing the step of retrieving electronic data comprises computer-executable instructions for performing the steps of:
a. for each URL of said initial set of URLs,
i. issuing a request to said URL; and
ii. receiving said electronic data from said URL;
when said electronic data from said URL includes additional URLs, adding said additional URLs to said list of URLs.

16. A system for obtaining targeted information from a database accessible through an electronic form, comprising:
a. an HTML-to-XHTML converter for receiving electronic data in HTML format and converting said electronic data into XHTML format;
b. a form parser for isolating electronic-form data from other portions of said electronic data and converting said electronic-form data into an electronic-form object model including at least one form field of said electronic-form data; and
c. a form filler for populating said at least one form field of said electronic-form object model with valid field data and initiating a request including said valid filed data to said database.

17. The system, as recited in claim 16, further comprising:
a. at least one classifier to evaluate said electronic-form object model and determine which of said at least one form field to populate to access said targeted information from said database.

18. The system, as recited in claim 16, wherein said requests initiated by said form filler are HTTP requests.
